(19) United States
(12) Patent Application Publication
(10) Pub. No.: US 2010/0168261 A1
(43) Pub. Date: Jul. 1, 2010

(54) FOAM AND FABRICATION METHOD THEREOF AND BUFFER MATERIALS COMPRISING THE SAME

(75) Inventors: Ching-Yu Hung, Taipei Hsien (TW); Li-Sheng Teng, Taipei Hsien (TW)

Correspondence Address: QUINTERO LAW OFFICE, PC, 615 Hampton Dr, Suite A202, Venice, CA, 90291, US

(73) Assignee: WISTRON CORP, Taipei Hsien (TW)

(21) Appl. No.: 12/388,472

(22) Filed: Feb. 18, 2009

(30) Foreign Application Priority Data
Dec. 31, 2008 (TW) TW97151733

(51) Int. Cl. C08L 3/02; C08J 9/35

(52) U.S. Cl. 521/84.1; 521/150

(57) ABSTRACT

Foam is provided. The foam includes starch, wood flour, a chemical auxiliary and resin, wherein the resin has a weight ratio exceeding 50%. The invention also provides a method for fabricating the foam. The method includes providing a foam raw material including starch, wood flour, a chemical auxiliary and resin, wherein the resin has a weight ratio exceeding 50%, blending the foam raw material and a foaming fluid to form a blend, and performing a foaming process to form foam.

### CROSS REFERENCE TO RELATED APPLICATIONS

This Application claims priority of Taiwan Patent Application No. 97151733, filed on Dec. 31, 2008, the entirety of which is incorporated by reference herein.

### BACKGROUND OF THE INVENTION

1. Field of the Invention

The invention relates to a foam, and more particularly to a foam containing starch and a fabrication method thereof.

2. Description of the Related Art

Polylactic acid (PLA) is a lactide polyester, with superior properties over conventional resins (plastics). PLA's raw material is derived from plant, not petroleum. Thus, it is suitable for sustainable use. Additionally, PLA can be decomposed into carbon dioxide and water by microorganisms in soil, without environmental pollution. It is expected that within ten years, PLA will gradually replace plastics having similar properties therewith such as PET and PS to become a popularly used polymer. In addition to conventional general plastic products (food containers or toys), in some reports, it has been disclosed that PLA can further be applied to the biomedical fields or packaging material fields for electrical products. PLA packaging material is transparent and burnished, such that a packaged product within, is clearly exhibited. Also, the PLA packaging material can provide considerably protection from damage for packaged products.

PLA, however, is hard, fragile and expensive such that its application is limited. In order to broaden the application scope of PLA products, some modifications have been developed. For example, use of environmental additives and some specific processing manners.

### BRIEF SUMMARY OF THE INVENTION

One embodiment of the invention provides a foam comprising starch, wood flour, a chemical auxiliary and resin, wherein the resin has a weight ratio exceeding 50%.

One embodiment of the invention provides a method for fabricating a foam comprising providing a foam raw material comprising starch, wood flour, a chemical auxiliary and resin, wherein the resin has a weight ratio exceeding 50%, blending the foam raw material and a foaming fluid to form a blend, and performing a foaming process to form foam.

One embodiment of the invention provides a buffer material comprising the disclosed foam.

The foam is prepared by low-cost starch with superior mechanical strength over conventional polylactic acid, wood flour obtained from pulp treatment and ethylene propylene diene monomer rubber, and further prepared as a buffer material for packaging electrical products. The buffer material is an environmentally friendly buffer packaging material with economic value.

A detailed description is given in the following embodiments.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

One embodiment of the invention provides a foam comprising starch, wood flour, a chemical auxiliary and resin.

The resin may comprise ethylene propylene diene monomer rubber, with a weight ratio exceeding 50%. The wood flour has a particle size exceeding 300 mesh.

The chemical auxiliary may comprise foaming agents such as azo foaming agents, antioxidants such as phenol antioxidants or phosphite antioxidants, flame retardants such as phosphorus compounds, bromine compounds, chlorinated paraffin or antimony trioxide, or lubricants such as paraffin lubricants.

One embodiment of the invention provides a method for fabricating a foam, comprising the following steps. A foam raw material comprising starch, wood flour, a chemical auxiliary and resin is provided. In the foam raw material, the resin has a weight ratio exceeding 50%. The foam raw material and a foaming fluid are then blended to form a blend. Next, a foaming process is performed to form foam.

The foaming fluid may comprise water. The foaming temperature of the foaming process is about 120-160° C. The shaping time thereof is about 12-30 minutes. The foam has a foaming ratio of about 1-15 times.

One embodiment of the invention provides a buffer material comprising the disclosed foam.

The buffer material may be a packaging material for electrical products.

The foam is prepared by low-cost starch with superior mechanical strength to conventional polylactic acid, wood flour obtained from pulp treatment and ethylene propylene diene monomer rubber, and further prepared as a buffer material for packaging electrical products. The buffer material is an environmentally friendly buffer packaging material with economic value.

Preparation of Foam

First, resin, modified starch, wood flour and a processing auxiliary are blended and uniformly dispersed to form a mixture. The mixture is then blended with an active agent, a foaming agent and a bridging agent in an airtight kneader to form a blend. The blend is then rolled on an open-type roller to achieve optimal dispersion.

The resin has a weight ratio of about 51-70 parts by weight. The modified starch has a weight ratio of about 20-40 parts by weight. The wood flour has a weight ratio of about 20-40 parts by weight. The processing auxiliary has a weight ratio of about 2-10 parts by weight (based on 100 parts by weight of resin). The active agent has a weight ratio of about 1-5 parts by weight (based on 100 parts by weight of resin). The foaming agent has a weight ratio of about 2-15 parts by weight (based on 100 parts by weight of resin). The bridging agent has a weight ratio of about 1-6 parts by weight (based on 100 parts by weight of resin).

Buffer Material Test

First, a foamed buffer material is cut into a proper size. A product is packaged by the buffer material and put into a packaging box. Next, the packaging box is placed on a drop machine. A dropping test is then performed. The dropping height is 91 cm. The results are shown in Table 1.

TABLE 1

| | Front | Back | Left | Right | Top | Bottom |
|---|---|---|---|---|---|---|
| G value | 63 | 93 | 76 | 144 | 152 | 147 |

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A foam, comprising:
a starch;
a wood flour;
a chemical auxiliary; and
an ethylene propylene diene monomer rubber,
wherein the ethylene propylene diene monomer rubber has a weight ratio exceeding 50%.

2. The foam as claimed in claim 1, wherein the wood flour has a particle size exceeding 300mesh.

3. The foam as claimed in claim 1, wherein the chemical auxiliary comprises foaming agents.

4. The foam as claimed in claim 1, wherein the chemical auxiliary comprises antioxidants, flame retardants or lubricants.

5. The foam as claimed in claim 3, wherein the foaming agent comprises azo foaming agents.

6. The foam as claimed in claim 4, wherein the antioxidant comprises phenol antioxidants or phosphite antioxidants.

7. The foam as claimed in claim 4, wherein the flame retardant comprises phosphorus compounds, bromine compounds, chlorinated paraffin or antimony trioxide.

8. The foam as claimed in claim 4, wherein the lubricant comprises paraffin lubricants.

9. (canceled)

10. A method for fabricating a foam, comprising:
providing a foam raw material comprising a starch, a wood flour, a chemical auxiliary and an ethylene propylene diene monomer rubber, wherein the ethylene propylene diene monomer rubber has a weight ratio exceeding 50%;
blending the foam raw material and a foaming fluid to form a blend; and
performing a foaming process to form a foam.

11. The method for fabricating a foam as claimed in claim 10, wherein the foaming fluid comprises water.

12. The method for fabricating a foam as claimed in claim 10, wherein the foaming process has a foaming temperature of 120-160° C.

13. The method for fabricating a foam as claimed in claim 10, wherein the foaming process has a shaping time of 12-30 minutes.

14. The method for fabricating a foam as claimed in claim 10, wherein the foam has a foaming ratio of 1-15 times.

15. A buffer material comprising a foam as claimed in claim 1.

16. The buffer material as claimed in claim 15, wherein the buffer material is a packaging material for electrical products.
